(19) United States
(12) Patent Application Publication
(10) Pub. No.: US 2025/0184016 A1
(43) Pub. Date: Jun. 5, 2025

(54) SIGNAL ANALYSIS AND SYNTHESIS USING SPECTROGRAM CONSTRUCTION AND INVERSION

(71) Applicants: Andre John Alfons Unger, Waterloo (CA); Kenneth Mark Walton, Etobicoke (CA); Robert William Enouy, Reston, VA (US)

(72) Inventors: Andre John Alfons Unger, Waterloo (CA); Kenneth Mark Walton, Etobicoke (CA); Robert William Enouy, Reston, VA (US)

(21) Appl. No.: 18/946,437

(22) Filed: Nov. 13, 2024

Related U.S. Application Data
(60) Provisional application No. 63/606,099, filed on Dec. 5, 2023.

(51) Int. Cl. H04B 17/309; H04B 17/391

(52) U.S. Cl. CPC H04B 17/309; H04B 17/3912

(57) ABSTRACT

A method for generating an analog signal for signal analysis, which includes the steps of receiving analog spectrogram data that characterizes one or more bands, constructing an analog signal from the analog spectrogram data, discretely sampling the analog signal for a time period comprised of a sequence of equal time intervals to create a digital signal with values that characterize the analog signal for each of the time periods, constructing a digital spectrogram from the digital signal, wherein the digital spectrogram represents the rate of change of amplitude with respect to time and frequency; and computing an analog spectrogram from the digital spectrogram, wherein an analog spectrogram represents the one or more bands in units of time, frequency and amplitude for the time period.

### TECHNICAL FIELD

The present invention relates generally to the field of signal processing; and more particularly, to methods of analyzing a received digital signal into a spectrogram, extracting the time and frequency peak amplitude information within the spectrogram into a set of bands in order to observe the received information, and then either replicating or otherwise modulating the time-frequency-amplitude path of the bands to modify or otherwise impart further information, and then using spectrogram inversion to synthesize the desired signal to transmit the new information.

### BACKGROUND

One approach to performing signal analysis is described by Unger, A. J. and R. W. Enouy in U.S. patent Ser. No. 11/867,733, filed on May 11, 2020, entitled “System and method of digital sound synthesis, signal transmission, and subsequent analysis using spectrogram inversion”, referred to herein as the '733 patent. The '733 patent discloses a method for constructing a digital spectrogram from a digital signal, extracting pulse information from the digital spectrogram, and then inverting the pulse information back into digital signal. The '733 patent demonstrated utility of the methodology with an embodiment related to speech recognition and synthesis.

The approach described in the '773 patent has some important limitations. First, all peaks within the digital spectrogram are ascribed to represent the time-frequency position of very-short-time-interval pulses. A methodology is described that groups contiguous peaks that span a very-long-time-interval into a single band. Second, a methodology is described for constructing the digital spectrogram that improves on certain aspects of the method described in the '773 patent, such as the removal of phase information. This ensures that the time-frequency-amplitude values of the band information can be correctly observed. Third, a methodology is described for inverting the bands back into a synthesized signal that also improves on certain aspects of the method described in the '733 patent, such as reintroducing the phase information.

### SUMMARY OF THE DESCRIPTION

The present invention provides a method to overcome limitations in the above-described approach.

The objective of the present invention is to embed time-frequency-amplitude band information into an analog or digital signal for subsequent use. An additional objective is to receive either an analog or digital signal and then to extract time-frequency-amplitude band information embedded within the signal.

The present invention takes advantage of the premise that transient waves of information within a transmitted analog or digital signal can be intercepted, measured, and then disaggregated into bands of information. This band information can be depicted on a time-frequency digital spectrogram, where each band spans a specific time interval and may modulate in frequency and amplitude within the interval. A digital spectrogram illustrates how these bands come into existence, persist, and ultimately dissipate. The information contained within, and therefore expressed by, these bands can then be modified and used to synthesize an analog or digital signal for subsequent transmission.

The present invention provides a method for constructing a spectrogram from an input digital signal. The method begins by ensuring the signal is complex-valued and then integrating the received digital signal with respect to time. Next, the present invention samples the data from the time-integrated digital signal into a series of overlapping windows, applying filters to the sampled data within each window, and then computing the discrete Fourier transform of the data within each window to construct a complex-valued spectrogram. Next, the time derivative of the complex-valued information within the digital spectrogram is computed, followed by computing the real-valued magnitude of the time-derivatives thereby removing all phase information from the spectrogram. The present invention ensures that the time-frequency-amplitude bands of the peak values within the spectrogram represent physically meaningful information.

The present invention also provides a method for inverting the time-frequency-amplitude-continuous bands of energy information into a signal, and then resampling the synthesized signal into a digital signal. The present invention begins by obtaining the frequency of each band as a function of time, as well as its amplitude of the band as a function of time. Next, for each band, the present invention computes the phase angle based on the time-frequency information. Next, for each band, the amplitude is combined with the phase angle using a complex valued oscillator, and then inverted into a complex valued signal. This correctly reintroduces the phase information back into the signal. Finally, the resulting signal from each band is superimposed into an aggregate signal containing all bands.

In one embodiment, the method is used to synthesize an analog voltage signal. This voltage signal is used as part of a variable frequency drive to control the rotation speed and power to an electric motor. Initially, an energy band is specified that spans a specific time interval and varies in frequency and magnitude over the time interval. The band is then inverted to synthesize an analog signal, which is then transmitted to variable frequency drive rectifier circuit to generate the desired voltage signal to drive the motor. To demonstrate that the transmitted signal contains only the required energy band and not any unwanted harmonics that may damage the motor, the analog signal is then analyzed by sampling it into a digital signal and then constructing a digital spectrogram of energy as a function of time and frequency. The same energy band is then observed within the digital spectrogram and is extracted into an analog spectrogram. Thereafter, the energy band may be further modulated in either time, frequency, or amplitude to meet evolving transient load demands of the motor.

The present invention provides an overall method for generating an analog signal for signal analysis, which includes the steps of receiving analog spectrogram data that characterizes one or more bands, constructing an analog signal from the analog spectrogram data, discretely sampling the analog signal for a time period comprised of a sequence of equal time intervals to create a digital signal with values that characterize the analog signal for each of the time periods, constructing a digital spectrogram from the digital signal, wherein the digital spectrogram represents the rate of change of amplitude with respect to time and frequency; and computing an analog spectrogram from the digital spectrogram, wherein an analog spectrogram represents the one or more bands in units of time, frequency and amplitude for the time period.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a simplified block diagram of an embodiment of a method 1 which performs the sequential tasks of: receiving an analog spectrogram that includes band information, processing the band information into an analog signal, processing the analog signal into a digital signal, processing the digital signal into a digital spectrogram, and finally processing the digital spectrogram back into an analog spectrogram and observing the same band information therein;

FIG. 2 is a simplified block diagram of an embodiment of method 200 that receives an analog spectrogram and computes an analog signal;

FIG. 3 is a simplified block diagram of an embodiment of method 300 that receives an analog signal and computes a digital signal;

FIG. 4 is a simplified block diagram of an embodiment of method 400 that receives a digital signal and computes a digital spectrogram;

FIG. 5 is a simplified block diagram of an embodiment of method 500 that receives a digital spectrogram and computes an analog spectrogram;

FIG. 6 is a simplified block diagram that shows various physical and logical components of an embodiment of a computational device 600 which is used to execute methods 1, 200, 300, 400 and 500;

FIG. 7 illustrates a band which constitutes an analog spectrogram that may be input to method 1;

FIG. 8 is a simplified flowchart to compute an analog signal in a series of steps;

FIG. 9 illustrates the helical form of the synthesized Gaussian band signal from the input band illustrated in FIG. 7;

FIG. 10A illustrates the real projection while FIG. 10B illustrates the imaginary projection of the amplitude of the complex-valued Gaussian band signal from FIG. 9;

FIG. 11 illustrates an example of an idealized time-continuous analog signal s(t) as well as a discretely sampled digital version h(tₙ) of the same signal;

FIG. 12 is a simplified flowchart to integrate a digital signal h(tₙ) in a series of steps;

FIG. 13 is a simplified flowchart to window a complex-valued time-integrated digital signal h̅(tₙ) in a series of steps;

FIG. 14 illustrates an example of placing windows at the start and end of the example signal of FIG. 11;

FIG. 15 illustrates an example of sampling a digital signal into overlapping windows on the example signal of FIG. 11;

FIG. 16 is a simplified flowchart to compute a digital spectrogram in a series of steps;

FIG. 17 illustrates an example arrangement of a Fourier transform of the signal from each window with placement of the information into a digital spectrogram;

FIG. 18 illustrates an example visualization of a finite difference determination of a time derivative of the information within the digital spectrogram;

FIG. 19A illustrates both the input band transmitted as the digital signal h(tₙ) as well as a flood map of the magnitude of the digital spectrogram arising from processing the input band. FIG. 19B illustrates the peak amplitude of the magnitude of the digital spectrogram at time position [symbol] and frequency position ωₖ. The solid line on depicts all contiguous peak amplitudes found within the magnitude of the digital spectrogram;

FIG. 20 is a simplified flowchart to compute an analog spectrogram in a series of steps; and

FIG. 21A illustrates the time-frequency path while FIG. 21B illustrate the time-amplitude path of the smoothed band [symbol] (t,ω) fitted to [symbol] in FIG. 19B. FIG. 21A also depicts the flood map of the magnitude of the digital spectrogram arising from processing the input band.

### DETAILED DESCRIPTION

The invention now will be described more fully herein, after with reference to the accompanying drawings, which form a part hereof, and which show, by way of illustration, may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Analog signal—a time-continuous signal, where the amplitude as a function of time is used to transmit information. The amplitude of the analog signal may take units of power, voltage or any other relevant measurement characteristic of an embodiment.

Digital signal—is obtained by discretely sampling an input analog signal in time, where the amplitude is accumulated and averaged over a constant sampling interval in time, along the entire temporal length of the input signal. The amplitude of the digital signal has the same units as the input analog signal.

Digital spectrogram—a discrete time-frequency-amplitude representation of information extracted from a digital signal. For any given time within the digital spectrogram, the amplitude at all frequencies obtained from application of a discrete Fourier transform to digital signal data are displayed, where these frequencies range from zero to the Nyquist frequency. The amplitude of the digital spectrogram has the same units as the input digital signal when differentiated with respect to frequency.

Band—the time-frequency-amplitude path of information. In certain embodiments a band may be provided as input where the amplitude of the band may be expressed in units of energy, volts, amperes, or any other relevant measurement characteristic of the embodiment. In other embodiments, a band may be observed within and extracted from a digital spectrogram as a set of contiguous discrete peak amplitudes. Here, the amplitude of the band will have the same units as the digital spectrogram. Note that the frequency and amplitude of the band may vary as a function of time which is referred to herein as frequency modulation as well as amplitude modulation. In certain embodiments, the time continuous function may be expressed by the parameters of a closed-form mathematical function. In other embodiments, the band may instead be characterized by a set of discrete time-frequency-amplitude values.

Analog spectrogram—the time-frequency continuous interval that encapsulates a single band, or a set of bands. The analog spectrogram specifies the time datum of the interval, the start time of each band relative to the time datum, as well as the initial phase angle at the start time of each band.

### Generalized Operation

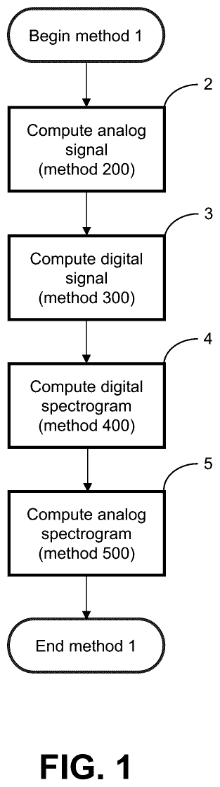

FIG. 1 is a simplified block diagram of an embodiment of a method 1 which performs the sequential tasks of: receiving an analog spectrogram that includes band information, processing the band information into an analog signal, processing the analog signal into a digital signal, processing the digital signal into a digital spectrogram, and finally processing the digital spectrogram back into an analog spectrogram and observing the same band information therein.

Method 1 has application as part of a variable frequency drive (VFD) used to control the operation of an electric motor. A conventional VFD that receives alternating current (AC) electricity is composed of a rectifier bridge converter, a direct current (DC) link, and an inverter. Voltage signals generated by conventional VFDs are not smooth and continuous in time-frequency-amplitude and consequently induce harmonic currents within the motor that result in reduced power efficiency as well as internal damage. Consequently, motors controlled by VFDs are designed for definite-purpose inverter-fed duty in accordance with Part 31 of NEMA Standard MG-1.

Advantageously, method 1 can be used to direct the inverter within a VFD to generate a voltage signal that is smooth and continuous in time-frequency-amplitude and does not exhibit any harmonics. Therefore, the power efficiency of the motor can be retained even as the frequency and amplitude of the voltage signal is being modulated. Moreover, the motor does not have to be over-designed to resist internal damage and can be as light-weight as possible for use in applications such as electric vehicles.

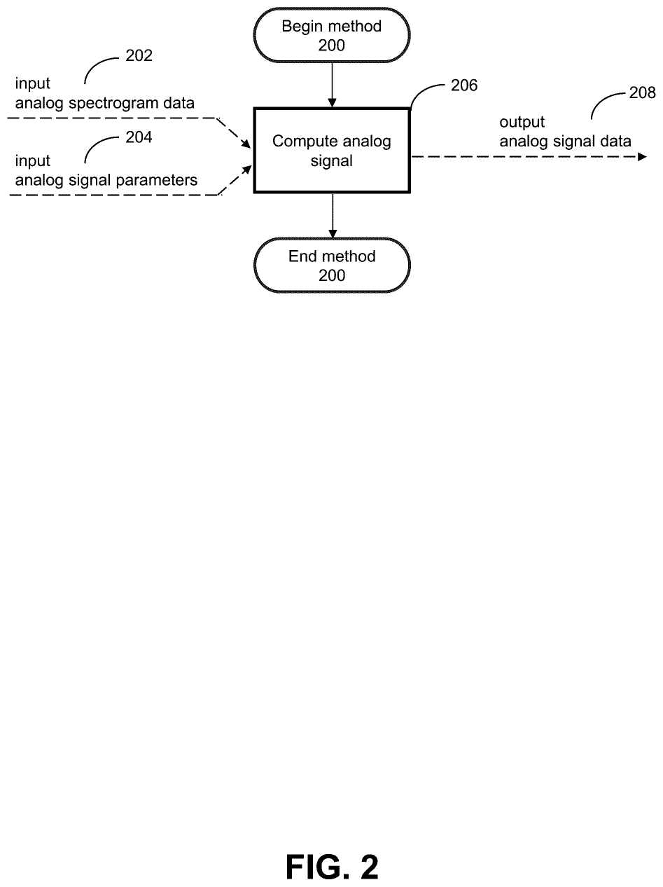

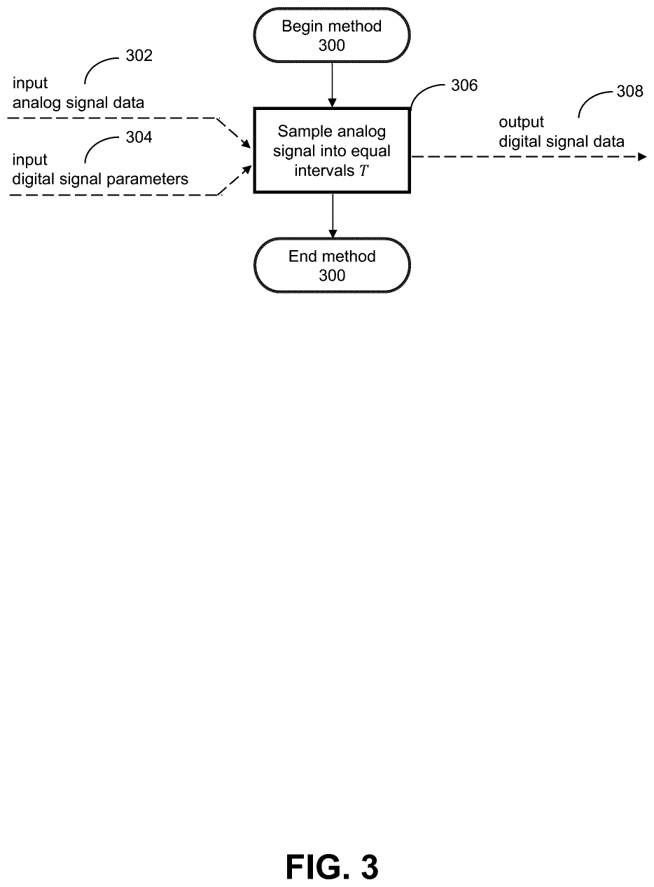

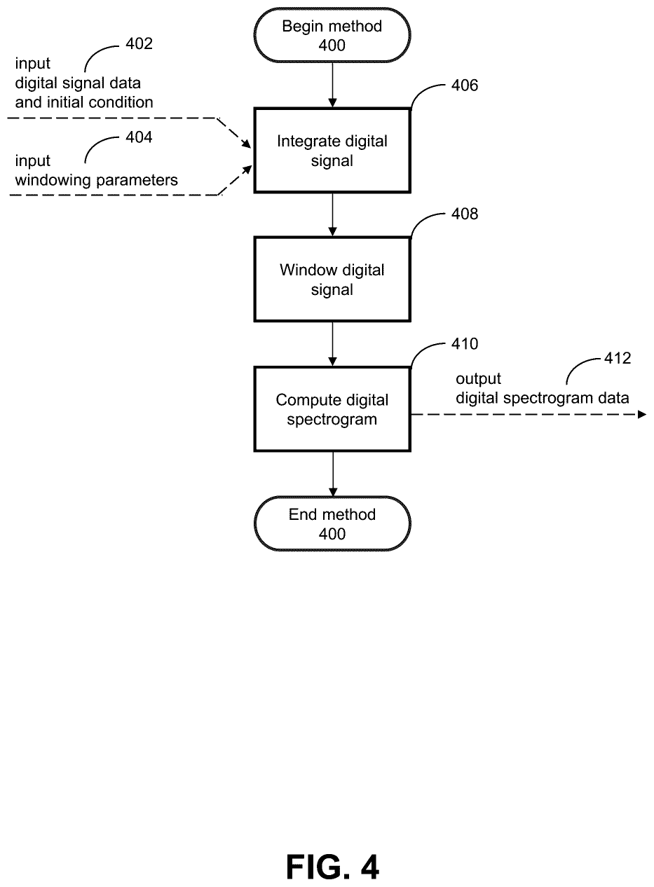

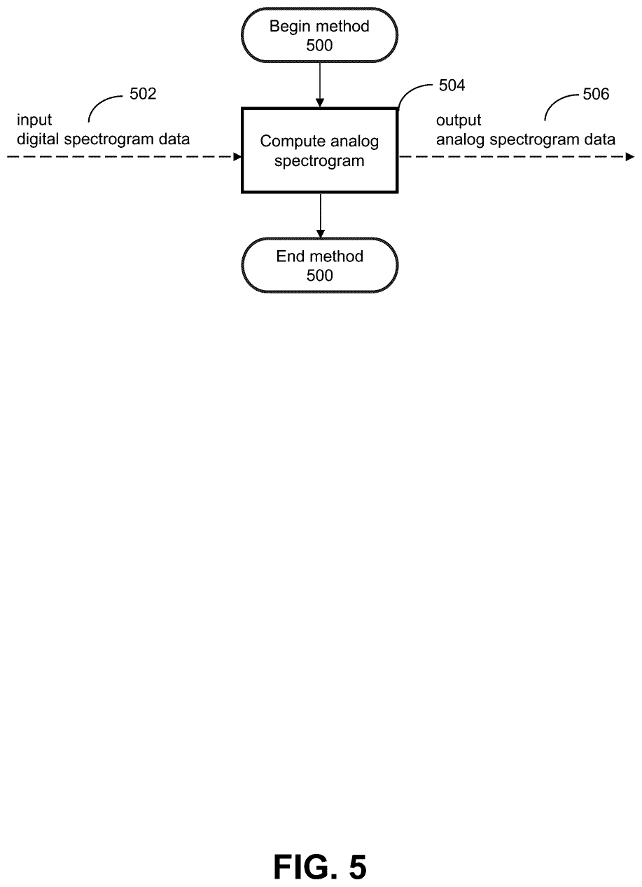

FIGS. 2, 3, 4 and 5 are simplified block diagrams of methods 200, 300, 400 and 500 that describe each of the sequential tasks of method 1. Specifically, FIG. 2 is an embodiment of a method 200 that receives an analog spectrogram and computes an analog signal. FIG. 3 is an embodiment of a method 300 that receives an analog signal and computes a digital signal. FIG. 4 is an embodiment of a method 400 that receives a digital signal and computes a digital spectrogram. FIG. 5 is an embodiment of a method 500 that receives a digital spectrogram and computes an analog spectrogram. Each of the simplified block diagrams for methods 200, 300, 400 and 500 focus specifically on identifying their input, output and general computational step for the purpose of identifying the similarity between these methods. Implementation details of the general computational step are specified below.

Method 1 is implemented by the sequential arrangement of methods 200, 300, 400 and 500 as depicted on FIG. 1. These methods can be combined in different arrangements to solve a variety of problems. Method 1 is an embodiment of one such application.

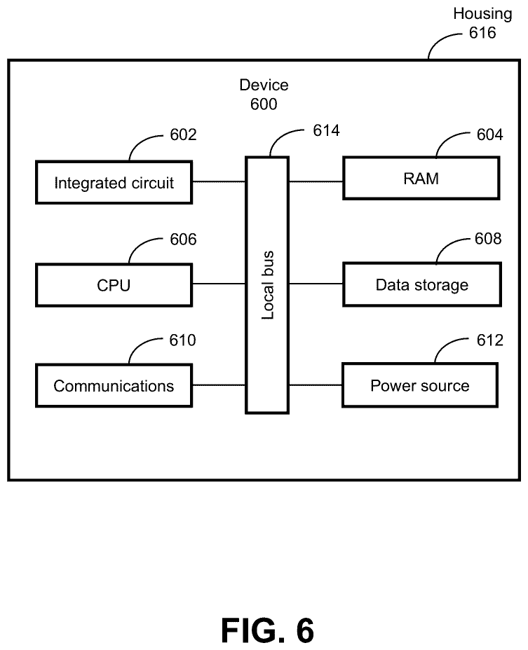

FIG. 6 is a simplified block diagram of an embodiment of a stand-alone computational device 600 that is used to execute methods 1, 200, 300, 400 and 500. As shown, device 600 has several physical and logical components, including a central processing unit (“CPU”) 602 (comprising one or more processors), random access memory (“RAM”) 604, an integrated circuit 606 in the form of either an application specific integrated circuit (ASIC) or a field-programmable gate array (FPGA), data storage 608, communications 610, power source 612, and a local bus 614 enabling CPU 602 to communicate with the other elements of device 600.

CPU 602 executes an operating system, and all or part of the steps comprising methods 1, 200, 300, 400 and 500, as described below in greater detail. Integrated circuit 606 executes the remaining steps comprising methods 1, 200, 300, 400 and 500, not executed on CPU 606, and as coordinated by CPU 602, where these steps of methods 1, 200, 300, 400 and 500 are flashed onto the integrated circuit 606. RAM 604 provides responsive volatile storage to CPU 602. Data storage 608 stores a database of all input and output data, software scripts in Python, C, C++ and any other programmable language, and executable binary code, associated with method 1. During operation of the device 600, methods 1, 200, 300, 400 and 500, and the related data and executable binary code may be retrieved from the data storage 608 and placed in RAM 604 to facilitate execution. Communications 610 can interact with and receive data and signals from various devices, such as an audio input signal from an audio or bit input device such as microphone. Communications 610 can also enable an administrator or user to provide information via an input device, for example a keyboard and mouse. Communications 610 can transmit data to output devices, for example, to an audio or bit output device such as a stereo speaker. Communications 610 permits communication with other systems, such as other computing devices and servers remotely located from the device 600, such as for a typical cloud-based access model. Communications 610 can receive or transmit a signal wirelessly using radio waves for cellular, Wi-Fi, Bluetooth, or analogous peer-to-peer data transfer protocol. Communications 610 can receive and transmit a signal using any type of electromagnetic radiation, such as light waves through fibre optic cables, using a suitable peer-to-peer data transfer protocol. A housing 616 provides an enclosure for elements 602 to 612 where the housing may be either portable or in a fixed location. CPU 602, integrated circuit 606, as well as all other elements of device 600 receive power from a power source 612, which may be internal or external DC battery, or an AC power supply. In certain embodiments, the power source 612 may be a combination of power sources.

In further embodiments, the subject invention can be run on other computing devices, including, for example, a desktop computer, a laptop computer, a smartphone, a tablet computer, a smartwatch or other wearable computing device, distributed or cloud computing device(s), electromechanical device(s), or the like.

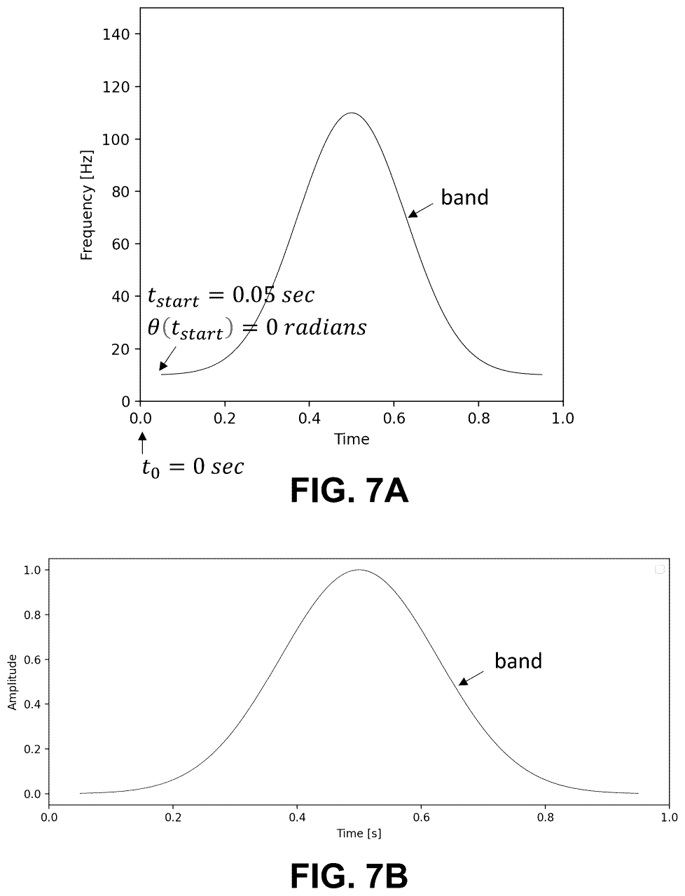

FIGS. 7A and 7B illustrate an example of a band that represents an analog spectrogram that may be input to method 1. In the VFD application, the band that would be inverted into an analog voltage signal and sent to an electric motor to control it to begin rotating at a speed proportional to the frequency of the band, and with a torque proportional to the amplitude of the band. In the example of FIGS. 7A and 7B, the motor would begin rotating when the band starts at 0.05 sec at a speed proportional to the band frequency of 10 Hz. The motor would then begin accelerating until the midpoint of the band at 0.5 sec as the frequency approaches 110 Hz, and the amplitude reaches its peak value. Thereafter, the motor would begin deaccelerating towards the end of the band at 0.95 sec as the frequency decreases back to 10 Hz and the amplitude approaches zero.

### Computing an Analog Signal

At step 2, method 1 employs a method 200 to compute an analog signal from an input analog spectrogram.

Method 200 receives analog spectrogram data 202. The input data includes parameters such as the time datum t₀ [sec] of the analog spectrogram, the start time of each band tₛₜₐᵣₜ [sec] relative to the datum, and the initial phase angle θ(tₛₜₐᵣₜ) [radians] of the each band. For the VFD application of method 1, the input analog spectrogram data is illustrated on FIGS. 7A and 7B.

In certain embodiments such as method 1, analog spectrogram data is received via communications 610, In other embodiments it is received from method 400. In yet other embodiments, analog spectrogram data is received from RAM 604 or data storage 608.

Method 200 receives analog signal parameters 204. Parameters 204 describe whether the analog signal that is to be computed from the input analog spectrogram data 202 is evaluated as: a time-continuous closed-form mathematical function, or at discrete intervals in time

$$𝒯 [ \frac{time}{sample} ]$$

for a piece-wise continuous mathematical function. In certain embodiments such as method 1, analog signal parameters 204 are received from communications 610. In other embodiments, parameters 204 are received from RAM 604 or data storage 608.

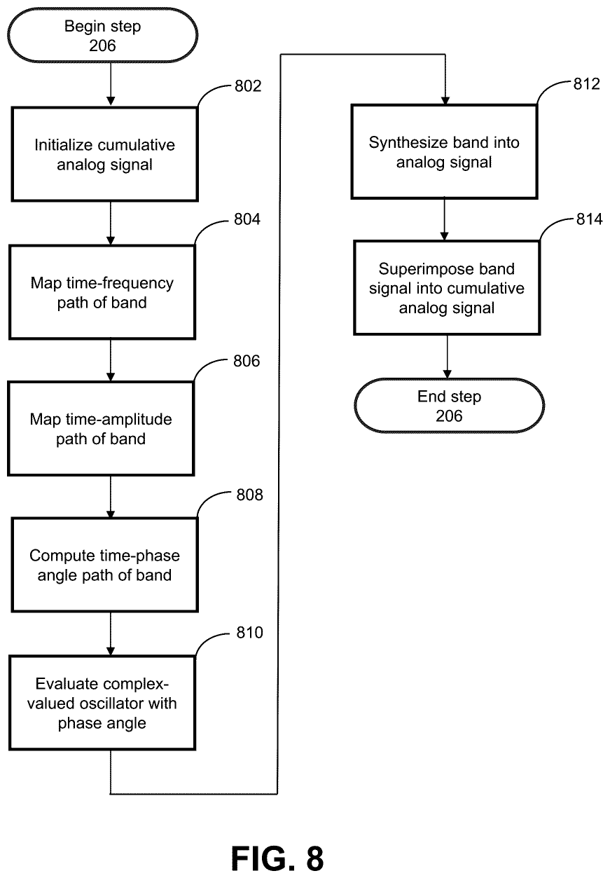

At step 206, the method 200 computes an analog signal in a series of steps as depicted on the simplified flowchart of FIG. 8.

A general representation of the amplitude of band information [symbol] (t,ω) at time t [sec] and frequency ω [Hz] within the analog spectrogram is denoted as:

$$S ( t , ω ) = \frac{{d}^{2} ε}{d ω dt} \qquad Equation ( 1 )$$

For the case where the amplitude of the information denotes the magnitude of energy ε(t,ω) [joules], [symbol] (t,ω) has units of

$$\frac{{d}^{2} ε}{d ω dt} [ joules / ( sec \cdot Hz ) ] .$$

Note that because the units of time and frequency in the denominator of the derivative cancel out, then d²ε/dωdt represents energy distributed as a smooth and continuously differentiable function across the time and frequency domain. Therefore, the analog spectrogram is a representation of energy in the time-frequency domain.

In general, band information within the analog spectrogram has an equivalent representation within an analog signal. For the case where the spectrogram d²ε/dωdt has units of energy [joules] or [joules/(sec·Hz)], then integrating [symbol] (t,ω) with respect to frequency synthesizes an analog signal s(t) as:

$$\begin{matrix}s ( t ) = \int S ( t , ω ) d ω \\ ⇒ s ( t ) ≡ \frac{d ε}{dt}\end{matrix} \qquad Equation ( 2 )$$

where the signal has units of power

$$\frac{d ε}{dt} [ joules / sec ]$$

as a function of time.

A general representation of a band information [symbol] (t,ω) as a function of time t [sec] and frequency ω [Hz] is given as:

$$S ( t , ω ) = 𝒜 ( t ) δ ( ω - {m}_{ω} ( t ) ) \qquad Equation ( 3 )$$

where [symbol] (t) is the amplitude, and δ is the Dirac delta function around the median frequency position m_{ω}(t) [Hz] of the band as a function of time. Note that [symbol] (t) may be either real or complex valued.

Referring to FIG. 8, which implements step 206 of method 200, at step 802, the cumulative analog signal is initialized by specifying the amplitude of the cumulative analog signal to be zero along its entire temporal length. Additionally, the start time of cumulative analog signal is the same as the time datum t₀ of the input analog spectrogram.

At step 804, the time-frequency path m_{ω}(t) of the band is mapped to the analog signal. This involves setting tₛₜₐᵣₜ of the band relative to t₀ of the synthesized signal. In the case that the cumulative analog signal is evaluated at discrete time intervals of [symbol] , then m_{ω}(t) is evaluated at these same intervals.

For the band used in the VFD application of method 1 as depicted in FIG. 7A, the time-frequency path m_{ω}(t) of the band is specified by the following Gaussian function:

$${m}_{ω} ( t ) = {ω}_{0} + {a}_{ω} exp \{ - {( \frac{t - {m}_{t}}{{σ}_{t}} )}^{2} \} \qquad Equation ( 4 )$$

where ω₀ [Hz] is the ambient frequency and a_{ω} [Hz] is the amplitude of the frequency deviation at the median time position mₜ of the band. FIG. 7A illustrates that the input band exists in the interval tₛₜₐᵣₜ≤t≤t_{end} with parameters: tₛₜₐᵣₜ=0.05 [sec], t_{end}=0.95 [sec], mₜ=0.5 [sec], σₜ=(mₜ−tₛₜₐᵣₜ)/2.5 [sec], ω₀=10 [Hz] and a_{ω}=100 [Hz]. Note that the time datum t₀=0 [sec]. The time-frequency path is not limited to a Gaussian function and is utilized here for simplicity.

At step 806, the method 200 maps the time-amplitude path [symbol] (t) of the band to the analog signal. This involves utilizing the same values of tₛₜₐᵣₜ, t₀ and [symbol] from step 804.

For the band used in the VFD application of method 1 as depicted in FIG. 7B, the time-amplitude path [symbol] (t) of the band is specified by the following Gaussian function, where [symbol] (t) is real valued:

$$𝒜 ( t ) = {a}_{t} exp \{ 1 {( \frac{t - {m}_{t}}{{σ}_{t}} )}^{2} \} \qquad Equation ( 5 )$$

and aₜ=1 [joules/(sec·Hz)]. The time-amplitude path is not limited to a Gaussian function and is utilized here for simplicity.

Note that the order of steps 804 and 806 are interchangeable.

A general representation of spectrogram inversion follows directly from Equations 2 and 3 as:

$$s ( t ) = 𝒜 ( t ) {\int }_{0}^{∞} δ ( ω - {m}_{ω} ( t ) ) {m}_{ω} ( t ) d ω \qquad Equation ( 6 )$$

The analog signal s(t) now has units of power [joules/sec]. Equation 6 can be equivalently expressed as:

$$s ( t ) = 𝒜 ( t ) exp \{ i θ ( t ) \} \qquad Equation ( 7 )$$

where i is the imaginary number, and exp{iθ(t)} is a complex-valued oscillator that is a function of the phase angle θ(t) [radians] along the temporal length of band object, where the phase angle is computed as:

$$θ ( t ) = 2 m {\int }_{{t}_{start}}^{t} {m}_{ω} ( t ) dt + θ ( {t}_{start} ) \qquad Equation ( 8 )$$

where tₛₜₐᵣₜ is the start time of the band which may differ from the time datum t₀, and θ(tₛₜₐᵣₜ) is the initial phase angle. The angular rate [radians/sec] is given as:

$$\frac{d θ ( t )}{dt} = 2 π {m}_{π} ( t ) \qquad Equation ( 9 )$$

where the choice of +2π denotes a counter-clockwise rotation around the unit circle. The angular rate ensures that the analog signal s(t) is smooth and continuous in time as m_{ω} (t) changes as a function of time. Equation 7 completes the definition of how to invert a band into a synthesized analog signal.

At step 808, method 200 computes the time-phase angle path θ(t) of the band along its temporal length according to Equation 8.

At step 810, method 200 evaluates the complex-valued oscillator exp{iθ(t)} as a function of the phase angle θ(t), according to Equation 7.

At step 812, method 200 synthesizes the analog signal s(t) by multiplying the complex-valued oscillator with the amplitude of the band [symbol] (t), according to Equation 7.

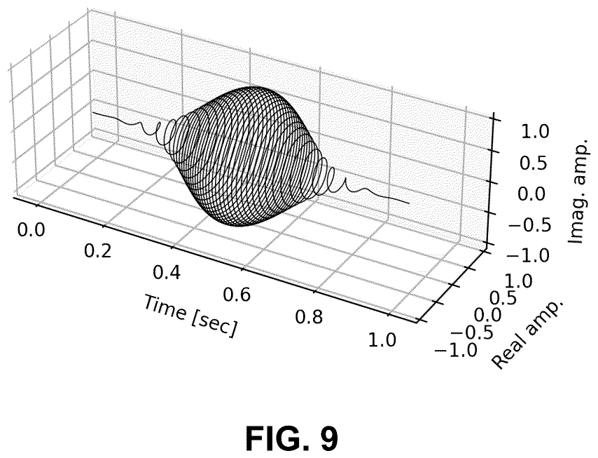

For the VFD application of method 1, the helical form of the synthesized Gaussian band signal is illustrated on FIG. 9, with the closed-from mathematical function given as:

$$s ( t ) = {a}_{t} exp \{ - {( \frac{t - {m}_{t}}{{σ}_{t}} )}^{2} \} exp \{ 2 π i [ {ω}_{0} t + \frac{{a}_{ω} {σ}_{t} \sqrt{π}}{2} erf ( \frac{t - {m}_{t}}{{σ}_{t}} ) ] \} \qquad Equation ( 10 )$$

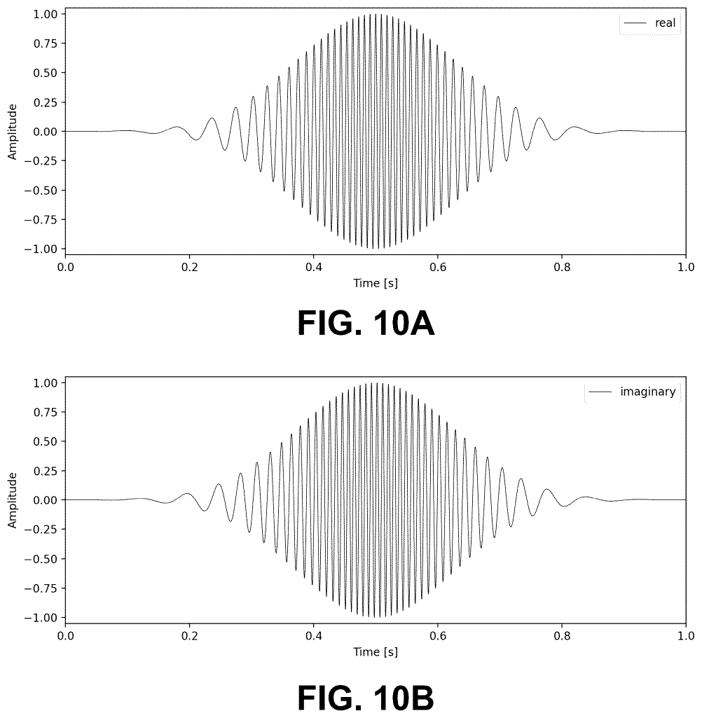

following the assumption that θ(tₛₜₐᵣₜ)=0 [radians]. FIG. 10A illustrates the real projection while FIG. 10B illustrates the imaginary projection of the amplitude of the complex-valued signal from FIG. 9.

At step 814, the method 200 superimposes the synthesized signal of a given band into the cumulative analog signal that aggregates all the band information from the analog spectrogram. Consecutive superposition of each band into a single signal represents the integration across the frequency interval 0≤ω<∞ as specified by Equation 6.

A skilled reader will appreciate that θ(t) in Equation 8 may not have a solution obtainable as a closed-form integration in the manner of the Gaussian band signal example for s(t) in Equation 10 and instead may require numerical integration to achieve a solution. Additionally, a skilled reader will appreciate that alternative forms [symbol] (t) may be used in Equation 8 in addition to the Gaussian band example. Additionally, a skilled reader will appreciate that Equation 9 may be defined using −2π as a clockwise rotation around the unit circle, with corresponding adjustments to Equations 7 and 8. Additionally, a skilled reader will appreciate that spectrogram inversion via Equations 6, 7 and 8 can proceed with [symbol] (t) being either real or complex valued.

Method 200 returns the cumulative analog signal data 208. In certain embodiments such as method 1, the analog signal data is directed to method 300. In other embodiments, the cumulative analog signal may be directed to any of RAM 604, data storage 608, or communications 610.

### Computing a Digital Signal

At step 3, method 1 employs a method 300 to compute a digital signal by sampling the analog signal generated at step 2

Method 300 receives analog signal data 302. In certain embodiments such as method 1, the analog signal data is received from 208 of method 200. In other embodiments, analog signal data may be received from RAM 604, data storage 608, or communications 610.

Method 300 receives the digital signal parameter 304. Parameter 304 describes the sampling interval parameter

$$T [ \frac{time}{sample} ]$$

to sample the analog signal into a digital signal. Note that T may be the same or different as [symbol] which is the interval on which analog signal is discretely evaluated. In certain embodiments such as method 1, the sampling interval parameter is received from communications 610. In other embodiments, the sampling interval parameter may be received from RAM 604 or data storage 608.

In general, the sampling interval

$$T [ \frac{time}{sample} ]$$

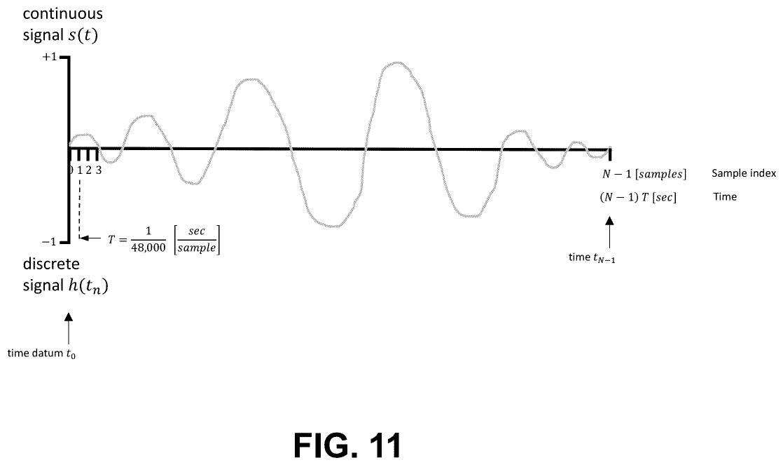

is used to sample an analog signal into a digital signal. FIG. 11 illustrates an example of an idealized time-continuous analog signal s(t) as well as a discretely sampled (digital) version of the same signal h(tₙ) in the observation interval n=0, 1, . . . , N−1 [samples]. Note that t [time] denotes continuous time while tₙ [time] denotes discrete time intervals. The first data point of the signal is at the time datum t₀, while the last data point is t_{N-1}. The relationship between the sampling interval T and values along the temporal length of the digital signal at discrete time tₙ [time] is given by:

$$T = \frac{{t}_{n + \frac{1}{2}} - {t}_{n - \frac{1}{2}}}{( n + \frac{1}{2} ) - ( n - \frac{1}{2} )} \qquad Equation ( 11 )$$

Note that the sampling process can be explicitly denoted with units of “sample”. For instance, a standard digital audio file can have 48,000 samples of data h(tₙ) in one second of a recording. Therefore, the time-sampling-process ratio would be denoted as

$$T = \frac{1}{48 , 000} [ \frac{seconds}{sample} ] .$$

The time observation interval of the signal would now be: (N−1) T [seconds].

At step 306, the method 300 preforms numerical integration on the analog signal at equally spaced time intervals, also referred to as sampling intervals, T to average this energy over the sampling interval and generate a digital signal h(tₙ). Equation 12 shows a mathematical representation of this digital sampling process:

$$h ( {t}_{n} ) = \frac{1}{T} {\int }_{n - \frac{1}{2}}^{n + \frac{1}{2}} s ( t ) dt \qquad Equation ( 12 )$$

Equation 12 samples the time-continuous amplitude information within the analog signal s(t) into time-discrete amplitude information within the digital signal h(tₙ). Moreover, there is a conservation of information quantity between the analog and digital signals over each sampling interval n=0, 1, . . . , N−1 [samples].

Method 300 returns the sampled digital signal data 308. In certain embodiments such as method 1, the digital signal data is directed to method 400. In other embodiments, the digital signal may be directed to RAM 604, data storage 608 or communications 610.

### Computing A Digital Spectrogram

At step 4, the method 1 employs a method 400 to compute a digital spectrogram from the digital signal generated at step 3.

Method 400 receives digital signal data 402. In certain embodiments such as method 1, the digital signal data is received from 308 of method 300. The digital signal data includes both the signal h(tₙ) as well as an initial condition. In other embodiments, digital signal data may be received from RAM 604, data storage 608, or communications 610.

Method 400 receives parameters 404 on how to window the digital signal data. In certain embodiments such as method 1, the digital signal windowing parameters are received from communications 610. In other embodiments, these parameters may be received from RAM 604 or data storage 608.

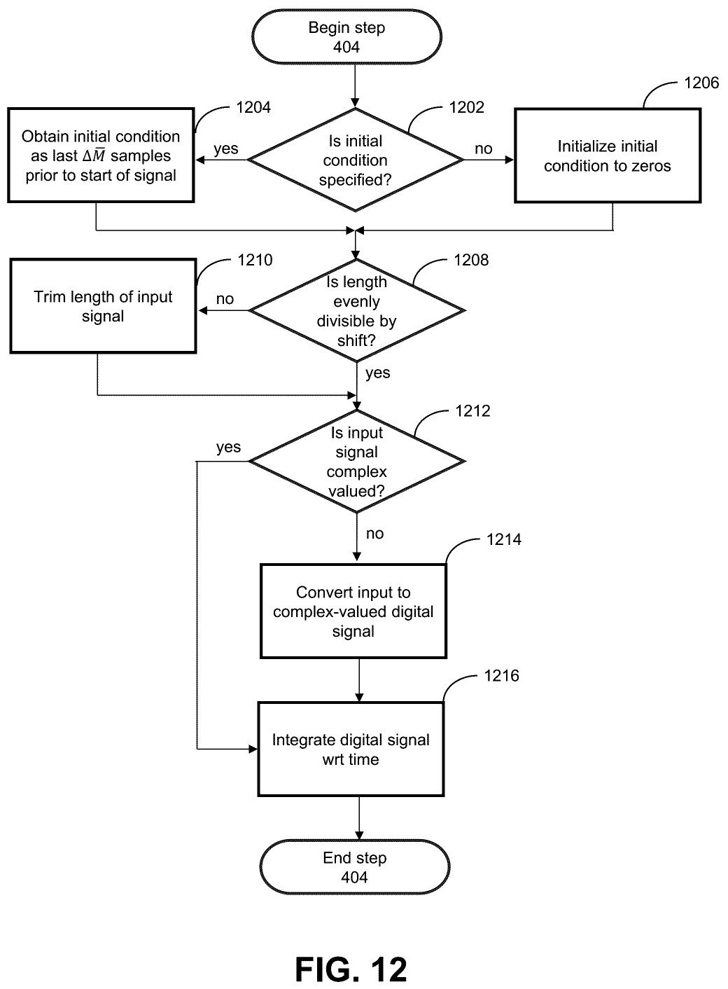

At step 406, method 400 integrates the digital signal data 402 in a series of steps as depicted on the simplified flowchart depicted on FIG. 12.

Referring to FIG. 12, at step 1202, the digital signal data is examined to determine whether an initial condition was specified. In an example, no initial condition may be specified if no information was observed and measured prior to the start of the signal h(tₙ). Alternatively, and initial condition may be specified when signal h(tₙ) is a continuation of an ongoing signal.

At step 1204, if an initial condition is specified, then the initial condition consists of last ΔM̅ samples of the ongoing signal prior to the start of h(tₙ) at time datum t₀, The initial condition is then appended to the start of h(tₙ). At step 1206, if an initial condition is not specified, then the initial condition is assigned to be a series of ΔM̅ samples of zero. This initial condition is then appended to the start of h(tₙ). The length of h(tₙ) is now N+ΔM̅ samples.

The windowing parameter ΔM̅ is an integer value and its utility in the windowing process is demonstrated below.

At step 1208, if the number of samples in the digital signal h(tₙ) is divisible by the windowing shift parameter Δm without remainder, then no modification is made to the digital signal. If there is a remainder, then the length of the signal should be truncated by discarding the last samples at the end of the signal until it is evenly divisible.

The windowing parameter Δm is an integer value and its utility in the windowing process is demonstrated below.

In certain embodiments such as method 1, it is known a priori that the digital signal is complex valued given that it was generated by methods 200 and 300. In other embodiments, a digital signal of unknown provenance may be received and input directly into method 400 at 402. Whether the signal is real or complex valued may be unknown prior to input. At step 1212, the digital signal is determined to be either real valued only or complex valued. If the digital signal is real-valued only, then at step 1214 it is converted to a complex-valued signal. To do this, the real-valued digital signal is assigned to the real-valued component of the complex-valued signal h(tₙ) and the imaginary-valued component of h(tₙ) is assigned zero.

At step 1216, the complex-valued digital signal h(tₙ) is integrated as:

$$\overline{h} ( {t}_{n} ) = \frac{1}{T} {\int }_{0}^{Δ \overline{M} + N - 1} h ( {t}_{n} ) dn \qquad Equation ( 13 )$$

where: the first ΔM̅ samples represent the initial condition, and the subsequent N samples in the interval n=0, 1, . . . , N−1 represents the input digital signal 402, and h̅(tₙ) is the time-integrated signal. Note that in the case that the amplitude of h(tₙ) was in units of [joules/sec], h̅(tₙ) has units of energy [joules] following integration across time nT [sec].

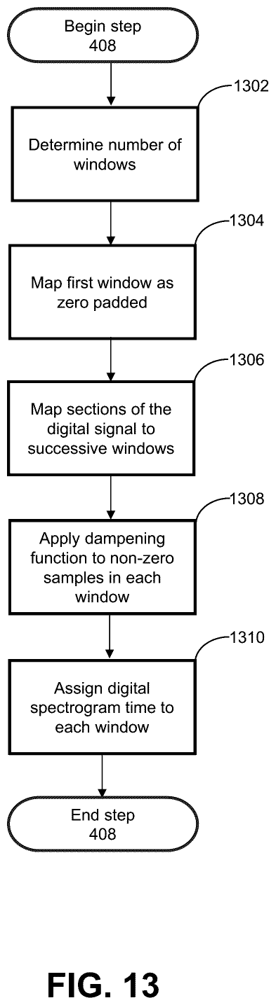

Referring back to FIG. 4, at step 408, method 400 windows the complex-valued time-integrated digital signal h̅(tₙ) in a series of steps as depicted on the simplified flowchart depicted on FIG. 13.

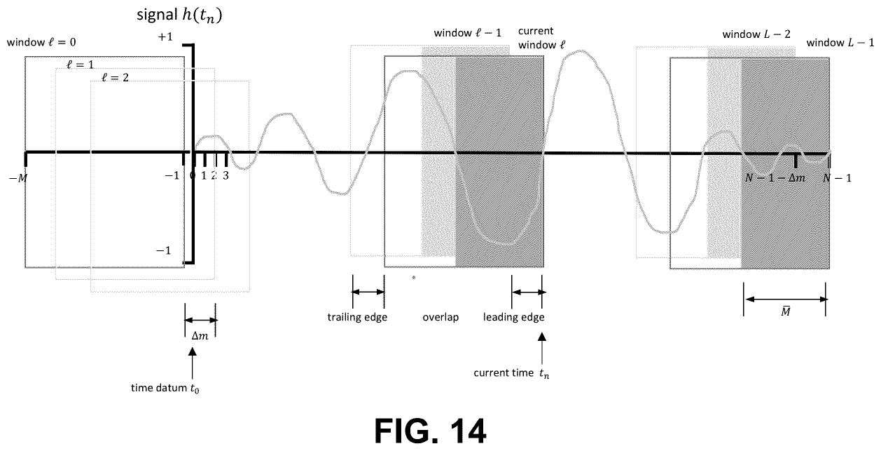

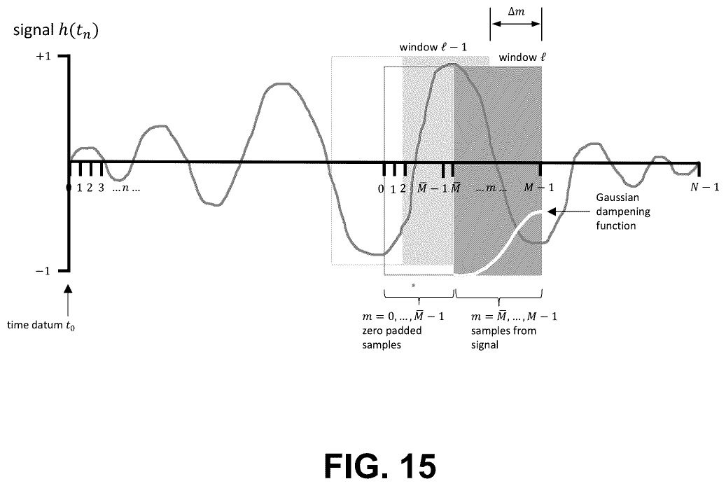

Referring to FIG. 13, at step 1302, the digital signal h̅(tₙ) is windowed by sectioning the signal into samples of identical length using a series of overlapping windows. In an example, FIG. 14 exhibits an idealized signal s(t) that is then digitally sampled into h(tₙ), time-integrated into h̅(tₙ), and then windowed into [symbol] =0, 1, . . . , L−1 for a total of L [windows]. The current window [symbol] spans an interval of time to observe, sample, and analyze the signal that has occurred immediately prior to the current time tₙ. Moreover, as the signal continues to evolve into the future, beyond the current time tₙ, it can then progressively be observed, sampled, and analyzed using additional windows at shifted intervals of Δm [samples]. FIG. 15 illustrates how each window [symbol] includes m=0, 1, . . . , M−1 samples for a total of

$$M [ \frac{samples}{window} ]$$

and where Δm [samples] is the shift along the digital signal h̅(tₙ) between adjacent overlapping windows [symbol] and [symbol] −1.

Note that Δm is subject to 1≤Δm<<M.

At step 1304, in the example of FIG. 14, one full window of zeros is placed prior to the start of the digitally sampled signal h(tₙ) prior to being time-integrated into h̅(tₙ). This window is denoted as window index [symbol] =0 and is used to contain the initial condition.

At step 1306, in the example of FIG. 15, sections of the digital signal h̅(tₙ) are mapped into successive windows [symbol] =0, 1, . . . , L−1. For a given window [symbol] at time tₙ, only the last m=M̅, . . . , M−1 samples of the window are mapped directly from the signal h̅(tₙ) while the first m=0, 1, . . . , M̅−1 samples of a window are zero padded. This mapping operation is denoted as h̅(tₙ)→h̅(m, [symbol] ). Note that while there is a unique value of h̅(tₙ) within the signal, that value may be mapped to different index positions of m within multiple windows [symbol] as shown on adjacent windows [symbol] −1 and [symbol] . The initial condition will now exist at the end of window [symbol] =0.

Note that

$$Δ \overline{M} = ( M - 1 ) - \overline{M} [ \frac{samples}{window} ]$$

is the number of non-zero samples of a window taken from the signal h̅(tₙ), with M̅ in the interval 0<M̅<M−1. For practical purposes, ΔM̅>>Δm.

At step 1308, a dampening function is applied to the last m=M̅, . . . , M−1 samples h̅(m, [symbol] ) of a given window [symbol] resulting in h̅(m, [symbol] ), as illustrated in FIG. 14. For the specific case where the dampening function takes a Gaussian form:

$${h}^{=} ( m , ℓ ) = = \overline{h} ( m , ℓ ) exp \{ - {( \frac{m - ( M - 1 )}{{σ}_{m}} )}^{2} \} \qquad Equation ( 14 )$$

where σₘ=ΔM̅/3. The purpose of the dampening function is to: progressively weight h̅(m, [symbol] ) by unity as m→M−1 towards the leading edge of the window; and, weight h̅(m, [symbol] ) by zero as m→M̅ to ensure a smooth and continuous transition into the zero padded region of the window in the interval m=0, 1, . . . , M̅−1. Alternative mathematical formulations of the dampening function may suffice, including variations of σₘ such as σₘ=ΔM̅/b where b is a real number.

At step 1310, the method 400 calculates and assigns the digital spectrogram time [symbol] [sec] to each window [symbol] =0, 1, . . . , L−1 as:

$${t}_{ℓ} = Δ m T ℓ \qquad Equation ( 15 )$$

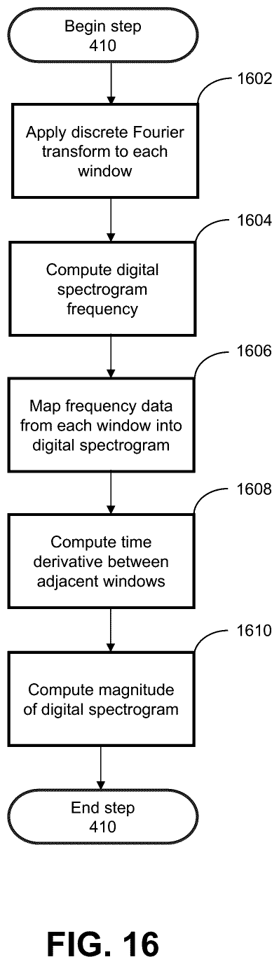

Referring back to FIG. 4, at step 410, method 400 computes the digital spectrogram in a series of steps as depicted on the simplified flowchart depicted on FIG. 16.

Now referring to FIG. 16, at step 1602, a discrete Fourier transform is applied to the digital signal data within each window. For window [symbol] =0, . . . L−1, the digital signal data within each sequential window h̅(m, [symbol] ) is transformed into the time-frequency domain. This transformation results in an expression of the average rate of change of energy ΔE/Δω( [symbol] ,ωₖ) with respect to frequency ωₖ at index k within window [symbol] which spans MT time, and is given as:

$$\frac{Δ E}{Δ ω} ( {t}_{ℓ} , {ω}_{k} ) = {\sum }_{m = 0}^{M - 1} {h}^{=} ( m , ℓ ) exp \{ 2 π i \frac{mk}{M} \} for k = 0 , 1 , … , M - 1 \qquad \begin{matrix}Equation \\ ( 16 )\end{matrix}$$

Note that both h̅(m, [symbol] ) and ΔE/Δω( [symbol] ,ωₖ) are complex valued. Note that ΔE/Δw is an intermediary value towards the construction of the digital spectrogram.

Note that application of the discrete Fourier transform Equation 16 must be consistent with Equation 10 in terms of the sign applied to 2π regarding either a +2π counter clockwise or −2π clockwise rotation around the unit circle.

At step 1604, the digital spectrogram frequency ωₖ is calculated as:

$${ω}_{k} = \frac{k}{MT} \qquad Equation ( 17 )$$

where k=0, 1, . . . ,

$$\frac{M - 1}{2} .$$

Note, MT [sec] specifies the temporal length of the window as well as the discretization of the digital spectrogram along the frequency axis. For instance, a choice of MT=1 [sec] then specifies Δω=1 [Hz]. Thus, the frequency resolution of the digital spectrogram is inversely proportional to the time resolution over which the digital signal is sampled.

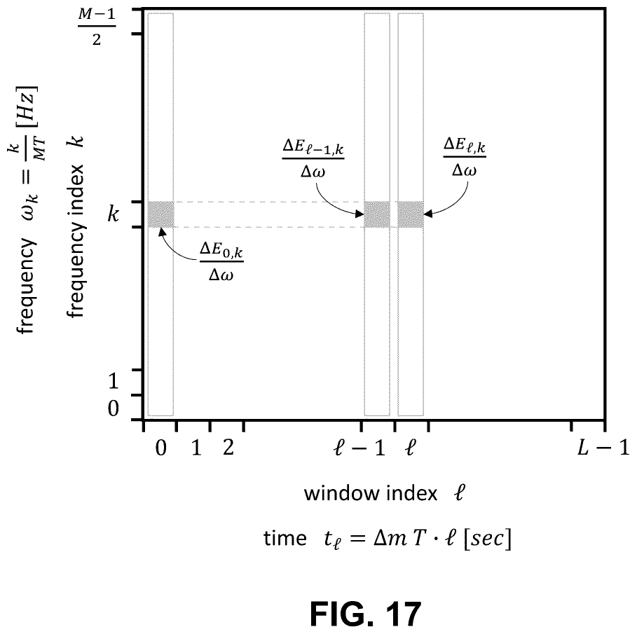

At step 1606, in the example of FIG. 17, values of ΔE/Δω ( [symbol] ,ωₖ) are mapped into a column of the digital spectrogram. Note that in FIG. 17, there is a condensed notation of ΔE/Δω ( [symbol] ,ωₖ) to [symbol] for window index [symbol] at frequency index k in the time-frequency domain. Given the symmetry in the Fourier transform operation of the discrete data h̅(m, [symbol] ) about the Nyquist frequency, values of [symbol] are only shown in the range k=0, 1, . . . ,

$$\frac{M - 1}{2} .$$

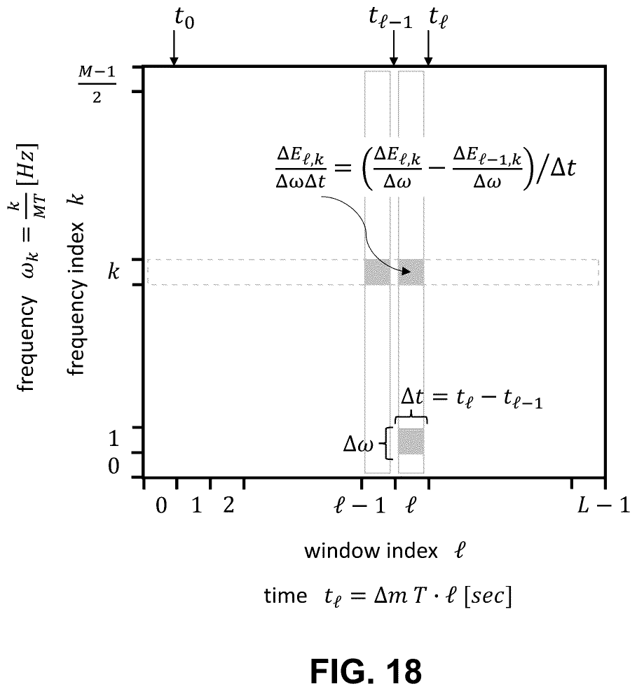

At step 1608, values of [symbol] [joules/(sec·Hz)] are computed by differencing adjacent columns of the spectrogram, and then dividing the difference by the time shift between the adjacent columns Δt= [symbol] − [symbol] =ΔmT [sec] as illustrated on FIG. 18, as:

$$\frac{Δ {E}_{ℓ , k}}{ΔωΔ t} = ( \frac{Δ {E}_{ℓ , k}}{Δω} - \frac{Δ {E}_{ℓ - 1 , k}}{Δω} ) / Δ mT \qquad Equation ( 18 )$$

The result of estimating the discrete derivative for each sequential window of information describing the change in energy with respect to time [symbol] is herein referred to as a digital spectrogram. The front zero padding ensures an initial condition of zero such that the Fourier transform of window index [symbol] =0 is zero:

$$\frac{Δ {E}_{0 , k}}{Δω} = 0.$$

Therefore, the first derivative position is implicitly defined as equal to the discrete Fourier transform of the first window, as:

$$\frac{Δ {E}_{ℓ , k}}{ΔωΔ l} ≡ \frac{1}{Δ mT} \frac{Δ {E}_{1 , k}}{Δω} - 0.$$

In another embodiment, spectrogram column [symbol] =1 contains the difference between [symbol] of the current chunk of digital signal and

$$\frac{Δ {E}_{ℓ - 1 , k}}{Δω}$$

from the end of the previous chunk which ensures continuity of [symbol] in time.

Note that [symbol] is complex valued.

At step 1610, the magnitude of digital spectrogram is computed as:

$$\frac{Δ {\hat{E}}_{ℓ , k}}{ΔωΔ t} = \sqrt{ℛ {( \frac{Δ {E}_{ℓ , k}}{ΔωΔ t} )}^{2} + 𝒥 {( \frac{Δ {E}_{ℓ , k}}{ΔωΔ t} )}^{2}} \qquad Equation ( 19 )$$

where

$$ℛ ( \frac{Δ {E}_{ℓ , k}}{ΔωΔ t} ) and 𝒥 ( \frac{Δ {E}_{ℓ , k}}{ΔωΔ t} )$$

denote the real and imaginary components of [symbol] .
Application of Equation 19 to the complex valued [symbol] to produce the real valued [symbol] results in a loss of phase information.

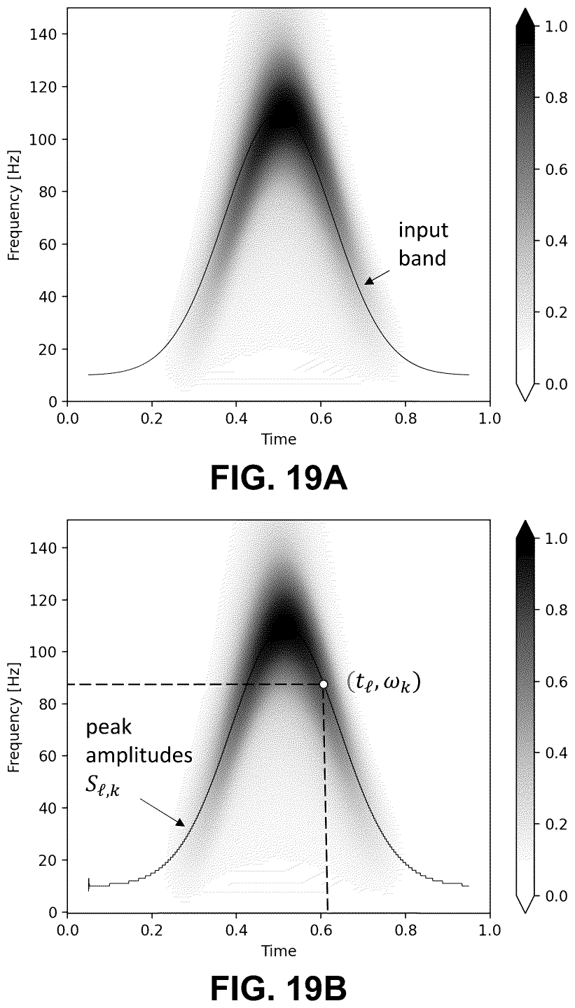

For the VFD application of method 1, FIG. 19A illustrates both the input band transmitted as the digital signal h(tₙ) as well as a flood map of the magnitude of the digital spectrogram arising from processing the input band. The magnitude of the digital spectrogram can be interpreted to represent the energy magnitude at a position in time and frequency. Parameters used to construct the digital spectrogram are

$$T = \frac{1}{48 , 000} [ \frac{sec}{sample} ] , M = 48 , 000 [ \frac{samples}{window} ] , Δ m = 1 [ \frac{sample}{window} ] , and Δ M = 3000 [ \frac{samples}{window} ] .$$

No initial condition was specified for the digital signal h(tₙ) at step 1202. Additionally, the digital signal h(tₙ) was not truncated at step 1208 given that its length was divisible by Δm without remainder. Finally, the digital signal h(tₙ) is complex valued.

In general, window parameters M, Δm, ΔM̅ and the dampening function in Equation 14 all act to influence the degree to which the magnitude of the digital spectrogram [symbol] can be used to approximate the analog spectrogram d²ε/dωdt in Equation 3. Reiterating the previous statement regarding the mapping operation h̅(tₙ)→h̅(m, [symbol] ), and that there is a unique value of h̅(tₙ) within the signal, and that that value may be mapped to different index positions of m within multiple windows [symbol] as shown on adjacent windows [symbol] −1 and [symbol] on FIG. 15. An increase in ΔM̅ results in h̅(tₙ) being mapped into more windows, with time [symbol] of the windows becoming progressively greater than tₙ of sample h̅(tₙ). This results in [symbol] being slightly lagged and smeared in time relative to h(tₙ) as illustrated on FIG. 19A which herein is referred to as numerical dispersion in time. This numerical dispersion in time can be minimized by adjusting ΔM̅→0. However, as ΔM̅→0 then [symbol] exhibits increasing numerical dispersion in frequency given that there are insufficient samples in each window to allow the discrete Fourier transform to resolve the frequency position of the peak amplitude of the band. Consequently, there is a trade-off wherein minimizing numerical dispersion in time must be balanced with minimizing numerical dispersion in frequency. The dampening function is applied to reduce the contribution of values of h(tₙ) that are furthest from the leading edge of the window where [symbol] is assigned, with these values exhibiting the greatest deviation between [symbol] and tₙ, thereby helping to minimize numerical dispersion in time and frequency. A value of Δm=1 ensures the correct amplitude of [symbol] for all frequency ωₖ such that [symbol] approximates d²ε/dωdt. For Δm>1 . . . , then the amplitude of

$$\frac{Δ {\hat{E}}_{ℓ , k}}{ΔωΔ t} = 0 when {ω}_{k} = \frac{κ}{T \cdot Δ m}$$

for κ=1, 2, 3 . . . . Moreover, the amplitude of [symbol] is progressively diminished between increasing harmonic intervals of κ. Finally, zero-padding the first m=0, 1, . . . , M̅−1 values of a window to a total number of M samples per window enables the user to prescribe the frequency discretization via Equation 17 without perturbing the balance in numerical dispersion between time and frequency, and maintain a Nyquist frequency of

$$\frac{M - 1}{2} .$$

Referring back to FIG. 4, method 400 returns the magnitude of the digital spectrogram data 410. In certain embodiments such as method 1, the magnitude of the digital spectrogram data is directed to method 500. In other embodiments, the magnitude of the digital spectrogram data may be directed to RAM 604, data storage 608 or communications 610.

### Computing an Analog Spectrogram

At step 5, the method 1 employs a method 500 to compute an analog spectrogram from the digital spectrogram generated at step 4.

Method 500 receives digital spectrogram data 502. In certain embodiments such as method 1, the digital spectrogram data is received from 412 of method 400. In other embodiments, digital spectrogram data may be received from RAM 604, data storage 608, or communications 610.

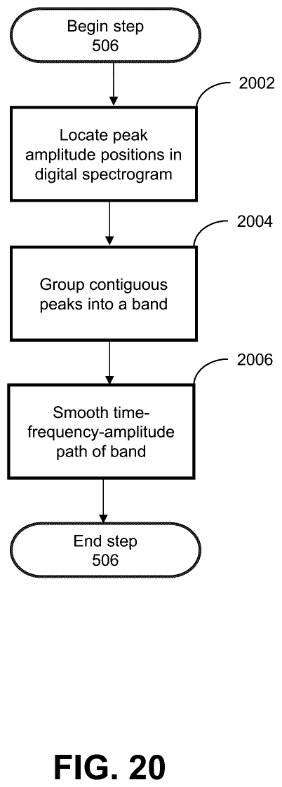

At step 504, the method 500 computes the analog spectrogram in a series of steps as depicted on the simplified flowchart of FIG. 20.

Referring now to FIG. 20, at step 2002, a peak finding approach is employed on the real-valued magnitude of the digital spectrogram data. For the VFD application of method 1, FIG. 19B illustrates the peak amplitude of the magnitude of the digital spectrogram at time position [symbol] and frequency position ωₖ. The solid line on FIG. 19B depicts all contiguous peak amplitudes found within the magnitude of the digital spectrogram. Note that there is a single peak amplitude at each time position

[symbol]

At step 2004, all contiguous peak amplitude positions within the digital spectrogram are collected into band objects, denoted as [symbol] . For the VFD application of method 1, there is a single band object. In other embodiments, there may be multiple [symbol] objects identified in a single digital spectrogram. One possible occurrence of multiple [symbol] objects would be when there are multiple peak amplitudes each at different frequency positions ωₖ all at a single time position [symbol] . This example would occur in the instance of harmonic bands.

Note that for the VFD application of method 1, [symbol] appears virtually identical to the input band on FIG. 19A although it is time-shifted because of the windowing sampling process employed by method 400. Note also that there are no other peaks within the digital spectrogram that could be inferred to represent extraneous information transmitted by the synthesized analog signal.

At step 2006, smooth and continuous time-frequency-amplitude functions are fit to the set of [symbol] band objects identified in the digital spectrogram. Smoothing may involve using a moving average or fitting polynomials, splines, or any suitable continuous or discrete function, to the time-frequency-amplitude values of [symbol] .

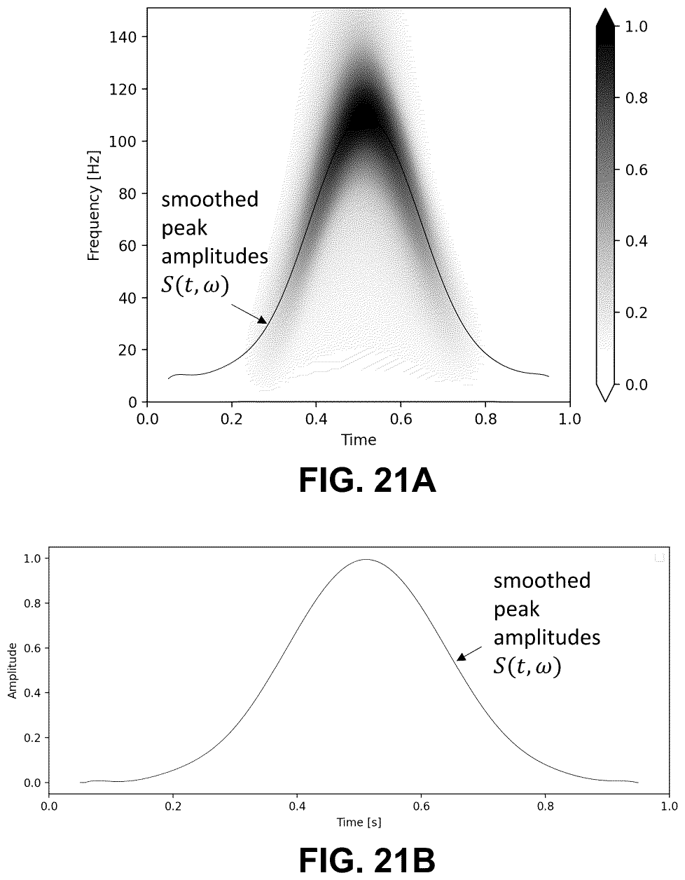

For the VFD application of method 1, the line on each of FIG. 21A and FIG. 21B illustrates the time-frequency-amplitude path of the smoothed band [symbol] (t,ω) fitted to [symbol] . For reference, FIG. 21A also depicts the flood map of the magnitude of the digital spectrogram arising from processing the input band. Note that FIG. 21A and FIG. 21B closely match the input band depicted on FIG. 19A. This is evidence to support the statement made earlier that band information within the analog spectrogram has an equivalent representation within an analog signal. In the context of methods 200, 300, 400 and 500, information is conserved as it is transformed in order from the analog spectrogram, analog signal, digital signal, digital spectrogram and then returning to the analog spectrogram. Moreover, method 1 can receive an input band and synthesize an equivalent analog signal for input into a VFD, where the synthesized signal is smooth and continuous in time-frequency-amplitude and consequently does not induce harmonic currents within the electric motor. This will maximize the efficiency of electric motors while also minimizing their mass.

Referring back to FIG. 5, method 500 returns the analog spectrogram data 506. In certain embodiments such as method 1, the analog spectrogram data is directed to data storage 608. In other embodiments, the analog spectrogram may be directed to 202 of method 200. In yet other embodiments, the analog spectrogram may be directed to RAM 604 or communications 610.

In summary, there are four innovations described herein that contribute to the novelty of this patent and are foundational to its utility. These innovations were not contemplated in the '733 patent and are itemized below.

The first innovation is part of the methodology used to construct the digital spectrogram from a received digital signal. This innovation is described in step 1216 and involves integrating the received digital signal with respect to time prior to windowing. This process serves to ensure that the digital spectrogram exhibits the correct amplitude of the band information as a function of time and frequency after differentiating the digital spectrogram with respect to time, as described in step 1608.

The second innovation is also part of the methodology used to construct the digital spectrogram from a received digital signal. This innovation is described in step 1308 and involves applying a dampening function to the non-zero samples within each window. This process is used to minimize the temporal smearing of information within the digital spectrogram by progressively increasing the weight of the data collected from the signal towards the leading edge of the window. This ensure that the time-amplitude representation of peak information extracted into the digital spectrogram is a close approximation to that in the received digital signal.

The third innovation is also part of the methodology used to construct the digital spectrogram from a received digital signal. This innovation is described in step 1610. Specifically, the magnitude of the complex valued spectrogram at each time-frequency position is computed. This results in the loss of all phase information thereby transforming the digital spectrogram into a real valued form. The utility of the real valued form of the digital spectrogram is that the pattern of peak amplitude locations clearly identifies the time-frequency-amplitude trace of the band information. In steps 2002 and 2004, these peaks are used to collect the band information from the digital spectrogram which are subsequently used to represent the analog spectrogram.

The fourth innovation is part of the methodology used to invert the analog spectrogram into an analog signal. This innovation is described in steps 804 to 812. This process involves utilizing the time-frequency path of a band to compute the phase angle along the band as a function of time. This reintroduces phase information back into the band that was formerly lost when constructing the real valued magnitude of the digital spectrogram. Then, the time-varying phase angle and amplitude along the band is utilized by a complex-valued oscillator to synthesize a complex valued signal representation of the band information. Multiple bands spanning the same interval of time can be superimposed into the same signal. The utility of the complex valued oscillator is that its amplitude remains unity via its real and imaginary components over all time and frequency intervals in an identical manner to a complex valued Fourier transform. Consequently, the complex valued oscillator does not introduce any time-frequency-amplitude periodic artifacts when inverting the time-frequency-amplitude trace of a band into its equivalent signal. Moreover, it enables the path of bands that exhibit time-frequency modulation to be correctly inverted into a signal, where that same path can then be observed by processing the signal back into a digital spectrogram.

Although the invention has been described with reference to certain specific embodiments, various modifications thereof will be apparent to those skilled in the art without departing from the spirit and scope of the invention as outlined in the claims appended hereto.

1. A computer-implemented method for generating an analog signal for signal analysis, comprising:
receiving analog spectrogram data that characterizes one or more bands;
constructing an analog signal from the analog spectrogram data;
discretely sampling the analog signal for a time period comprised of a sequence of equal time intervals to create a digital signal with values that characterize the analog signal for each of the time periods;
constructing a digital spectrogram from the digital signal, wherein the digital spectrogram represents the rate of change of amplitude with respect to time and frequency; and
computing an analog spectrogram from the digital spectrogram, wherein an analog spectrogram represents the one or more bands in units of time, frequency and amplitude for the time period.

2. The method of claim 1, wherein constructing an analog signal from the analog spectrogram data comprises computing a synthesized analog signal for each band, and wherein computing a synthesized analog signal comprises:
mapping the time-frequency path of the band to the analog signal;
mapping the time-amplitude path of the band to the analog signal;
computing the time-phase angle path of the band along its temporal length;
evaluating a complex-valued oscillator as a function of the phase angle; and
synthesizing an analog signal by multiplying the complex-valued oscillator with the amplitude of the band.

3. The method of claim 2, wherein each synthesized analog signal is superimposed to create a cumulative analog signal that aggregates all the band information from the analog spectrogram.

4. The method of claim 1, wherein discretely sampling the analog signal is performed by computing a digital sample for a succession of time intervals, T, and wherein a sample for a time interval is generated by numerically integrating the analog signal across the time interval to generate an average of the energy over the time interval.

5. The method of claim 1, wherein a constructed digital spectrogram has a horizontal axis that represents time and a vertical axis that represents frequency, and a height axis that represents the amplitude of energy at a given point in time and frequency.

6. The method of claim 1, wherein computing a digital spectrogram from the digital signal comprises:
converting the digital signal to a complex-valued digital signal;
integrating the complex-valued digital signal across all discrete samples for the time period;
generating a sequence of windows; wherein each window is an overlapping section of samples of the digital signal;
applying a dampening function to the data within each window;
performing a discrete Fourier transform on the data within each window to obtain a value for the average rate of change of energy with respect to frequency for the time period represented by each window;
arranging the Fourier transformed values from each window into columns, wherein each column represents a frequency for a time period; and
estimating the derivative of each sequential column, or window, to determine the change in amplitude with respect to time.

7. The method of claim 6 wherein the dampening function progressively increases the weighting towards the leading edge of the digital signal data within each window to ensure a smooth transition in the computed rate of change of amplitude with respect to time within the digital spectrogram.

8. The method of claim 1, wherein constructing an analog spectrogram from the digital spectrogram comprises:
at each column of the digital spectrogram, locating all contiguous peak amplitude positions and their associated frequencies;
grouping all contiguous peak amplitude positions within the digital spectrogram as belonging to a single band object; and
fitting smooth and continuous time-frequency-amplitude functions to the set of located bands.

9. A device for generating an analog signal for signal analysis, comprising:
a processor;
a communications interface in communication with the processor;
a memory in communication with the processor for storing instructions, which when executed by the processor, cause the device:
to receive analog spectrogram data that characterizes one or more bands;
to construct an analog signal from the analog spectrogram data;
to discretely sample the analog signal for a time period comprised of a sequence of equal time intervals to create a digital signal with values that characterize the analog signal for each of the time periods;
to construct a digital spectrogram from the digital signal, wherein the digital spectrogram represents the rate of change of amplitude with respect to time and frequency; and
to compute an analog spectrogram from the digital spectrogram, wherein an analog spectrogram represents the one or more bands in units of time, frequency and amplitude for the time period.

10. The device of claim 9, wherein constructing an analog signal from the analog spectrogram data comprises computing a synthesized analog signal for each band, and wherein computing a synthesized analog signal comprises:
mapping the time-frequency path of the band to the analog signal;
mapping the time-amplitude path of the band to the analog signal;
computing the time-phase angle path of the band along its temporal length;
evaluating a complex-valued oscillator as a function of the phase angle; and
synthesizing an analog signal by multiplying the complex-valued oscillator with the amplitude of the band.

11. The device of claim 10, wherein each synthesized analog signal is superimposed to create a cumulative analog signal that aggregates all the band information from the analog spectrogram.

12. The device of claim 9, wherein discretely sampling the analog signal is performed by computing a digital sample for a succession of time intervals, T, wherein a sample for a time interval is generated by numerically integrating the analog signal across the time interval to generate an average of the energy over the time interval.

13. The device of claim 9, wherein a constructed digital spectrogram has a horizontal axis that represents time and a vertical axis that represents frequency, and a height axis that represents the amplitude of energy at a given point in time and frequency.

14. The device of claim 11, wherein computing a complex-valued digital spectrogram from the digital signal comprises:
converting the digital signal to a complex-valued digital signal;
integrating the complex-valued digital signal across all discrete samples for the time period;
generating a sequence of windows; wherein each window is an overlapping section of samples of the digital signal;
applying a dampening function to the data within each window performing a discrete Fourier transform on the data within each window to obtain a value for the average rate of change of energy with respect to frequency for the time period represented by each window;
arranging the Fourier transformed values from each window into columns, wherein each column represents a frequency for a time period; and
estimating the derivative of each sequential column, or window, to determine the change in amplitude with respect to time.

15. The device of claim 14, wherein the dampening function progressively increases the weighting towards the leading edge of the digital signal data within each window to ensure a smooth transition in the computed rate of change of amplitude with respect to time within the digital spectrogram.

16. The device of claim 9, wherein constructing an analog spectrogram from the digital spectrogram comprises:
at each column of the digital spectrogram, locating all contiguous peak amplitude positions and their associated frequencies;
grouping all contiguous peak amplitude positions within the digital spectrogram as belonging to a single band object; and
fitting smooth and continuous time-frequency-amplitude functions to the set of located bands.
